(19) United States
(12) Patent Application Publication
(10) Pub. No.: US 2020/0270422 A1
(43) Pub. Date: Aug. 27, 2020

(54) METHOD FOR PRODUCING MODIFIED POLYESTER RESIN REINFORCED WITH CARBON FIBER

(71) Applicant: FTEX, INCORPORATED, Yokohama-shi (JP)

(72) Inventor: Takashi FUJIMAKI, Kanagawa (JP)

(73) Assignee: FTEX, INCORPORATED, Yokohama-shi (JP)

(21) Appl. No.: 15/931,662

(22) Filed: May 14, 2020

Related U.S. Application Data
(62) Division of application No. 15/545,770, filed on Jul. 24, 2017.

(30) Foreign Application Priority Data
Jan. 25, 2015 (JP) 2015-024685
Apr. 7, 2015 (JP) 2015-088766

(51) Int. Cl. C08K 7/06; C08J 5/04; C08J 5/10; C08L 67/00; C08L 69/00; C08G 63/91; C08K 3/04; C08K 5/1515

(52) U.S. Cl. CPC C08K 7/06; C08J 5/042; C08J 5/10; C08L 67/00; C08L 69/00; C08K 2201/003; C08K 3/04; C08K 5/1515; C08J 2367/02; C08J 2463/00; C08G 63/91

(57) ABSTRACT

A method for producing a modified polyester resin reinforced with carbon fiber, comprising reacting a mixture containing (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst, and (E) a spreader of 0.01 to 1 part by weight at a temperature equal to or more than a melting point of the thermoplastic polyester to increase a melt viscosity.

This is a divisional of application Ser. No. 15/545,770, filed Jul. 24, 2017, which is a National Stage of International Application No. PCT/JP2015/075006, filed Sep. 2, 2015, claiming priority from Japanese Patent Application No. 2015-024685, filed Jan. 25, 2015, and Japanese Patent Application No. 2015-088766, filed Apr. 7, 2015 the contents of which are hereby incorporated by reference into this application.

### TECHNICAL FIELD

The present invention relates to a method for producing a modified polyester resin reinforced with carbon fiber, comprising heating (A) a thermoplastic polyester, (B) a carbon fiber, (C) a polyfunctional epoxy resin-based coupling agent, (D) a coupling reaction catalyst, and (E) a spreader to a temperature equal to or more than a melting point of this thermoplastic polyester to increase melt viscosity.

### BACKGROUND ART

A conventional thermoplastic polyester includes, for example, a polyethylene terephthalate (PET), a polybutylene terephthalate (PBT), and a polycarbonate (PC) as a saturated aromatic polyester. These polyesters feature physical properties such as excellent transparency, mechanical strength, and rigidity as a thermoplastic resin and are widely used as, for example, fibers, films, and plastics. Especially, in the plastics field, molded products are widely used for, for example, bottles, sheets, containers, daily necessities, vehicle interior decorations, machine components, electric and electronic materials, building materials, civil engineering materials, and various kinds of industrial goods.

Additionally mixing a glass fiber or a carbon fiber to these polyesters to produce a thermoplastic composite material improves various properties such as mechanical strength and heat resistance. Thus, the polyesters have been used for further high-grade applications. Especially, since glass fiber is inexpensive, a large amount of the thermoplastic polyester composite material (PET composite materials, PBT composite materials, PC composite materials, and similar materials) reinforced by glass fiber has been used. Meanwhile, since carbon fiber features high strength but is very expensive, thermoplastic polyester composite materials produced by combining with carbon fiber have been used in extremely small amounts for only special applications. However, taking advantage of the high strength and high quality, a large amount of carbon fiber has been used as a thermosetting epoxy composite material for, for example, sporting goods characterized by high quality such as fishing rods, golf tees, and tennis goods, and especially for aircraft airframes recently.

Recently, in advanced industrial fields such as civil engineering/construction, automotive industry, Shinkansen train business, aerospace industry, and linear motor cars, as well as further weight reductions and energy savings through improvements in mechanical strength of constituent materials, further improvements in performance such as corrosion resistance, electric properties, heat resistance, and heat radiation performance have been requested. Generally, increasing the molecular weight of a synthetic resin improves moldability and the physical properties. However, since the production method for polyester is a polycondensation method, it is difficult to obtain a high-molecular weight polymer of, for example, 50000 or more. In a melted state, the polyester is a low-melting viscosity polymer like a starch syrup. It is extremely difficult to produce, especially to stably produce an extrusion-molded product by a horizontal extrusion method. A solid state polymerization method that increases the medium-molecular weight polymer of this polyester to around twice requires several hours, resulting in low productivity. Furthermore, the method has a weak point of requiring the large-scale manufacturing equipment of a petrochemical complex.

As described in Patent Documents 1, 2, and 3, the inventors have provided the following production method by a reactive extrusion method using a compact, inexpensive facility. The method causes a medium-molecular weight polymer of a polyester with carboxyl groups at a molecular end to react to and to be extruded together with an epoxy resin-based coupling agent (also referred to as a chain extender and a viscosity improver) and a coupling reaction catalyst to cause the polyesters to react to one another. Thus, the method achieves high productivity in which the molecular weight is increased in a short time, equal to or less than several minutes. Although the production methods of Patent Documents 1 to 3 significantly improved moldability through an increase in melt tension of the polyester, the improvement in mechanical physical property was barely observed.

### Patent Document 1: Japanese Patent No. 3503952

### Patent Document 2: WO 2009/004745

Patent Document 3: U.S. Pat. No. 8,258,239

### SUMMARY OF THE INVENTION

### Technical Problem

Not only further weight reductions and energy savings through improvements in mechanical physical properties, but also further improvements in performance such as corrosion resistance, conductivity, heat resistance, and heat radiation performance are being sought for constituent materials for advanced industrial fields such as civil engineering/construction, automotive industry, Shinkansen train business, aerospace industry, linear motor cars, etc. Especially, further improvements in performance of constituent materials in applications such as synthetic wood materials for construction outside a residence, weight-reduced materials for multistory buildings, high-strength/corrosion-resistant materials for coastal expressways, corrosion-resistant/high-strength materials for marine structures, weight-reduced materials for small flying objects “drones”, weight-reduced/corrosion-resistant materials for flying boats, and high strength/weight-reduced materials for automobiles are being sought.

An object of the present invention is to provide a method for producing a modified polyester resin reinforced with carbon fiber that has high strength and improved moldability and a method for producing a molded material having high strength and reduced weight by molding the modified polyester resin reinforced with carbon fiber into sheets, boards, profile extruded products, pipes, foam, and similar products.

### Solution to the Problem

The present invention is a method for producing a modified polyester resin reinforced with carbon fiber in which (A) a thermoplastic polyester, (B) a carbon fiber, (C) a polyfunctional epoxy resin-based coupling agent, (D) a coupling reaction catalyst and (E) a spreader are heated and mixed to cause a coupling reaction to produce the modified polyester resin reinforced with carbon fiber with increased melt viscosity and improved moldability. The present invention is a method for producing a molded product that improves various physical properties such as mechanical strength, weight reduction, and corrosion resistance by molding the obtained modified polyester resin reinforced with carbon fiber. Adjustment of the melt viscosity, which is the most important part of the present invention, can be controlled by additive amounts of the polyfunctional epoxy resin-based coupling agent and the coupling reaction catalyst. Note that, the additive amounts of the polyfunctional epoxy resin-based coupling agent and the coupling reaction catalyst need to be controlled again according to the amount of carbon fiber.

That is, the present invention is made up of the following first to eighth inventions.

The first invention is a method for producing a modified polyester resin reinforced with carbon fiber, comprising reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester to increase a melt viscosity.

The second invention is a method for producing a modified polyester resin reinforced with carbon fiber, comprising reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester by a reactive extrusion method to adjust a melt flow rate (MFR) in accordance with JIS K6760 (at 260° C. and under a load of 2.16 kg) to 20 g/10 minutes or less.

The third invention is the method for producing a modified polyester resin reinforced with carbon fiber according to the inventions above, wherein the thermoplastic polyester has an intrinsic viscosity of 0.60 to 1.25 dl/g, and the thermoplastic polyester is one or more kinds selected from the group consisting of a polyethylene terephthalate, a polybutylene terephthalate, a polyethylene terephthalate-based copolymer, a polycarbonate, and a recycled product of a molded product recovered from the polyethylene terephthalate, the polybutylene terephthalate, the polyethylene terephthalate-based copolymer, and the polycarbonate.

The fourth invention is the method for producing a modified polyester resin reinforced with carbon fiber according to the inventions above, wherein the carbon fiber has a specific gravity of 1.5 to 2.2, a fiber diameter of 7 to 18 μm, a tensile strength of 580 to 4,200 MPa, a modulus of elasticity in tension of 35 to 250 GPa, an extension of 0.3 to 3%, and a carbon content by percentage of 95% or more.

The fifth invention is the method for producing a modified polyester resin reinforced with carbon fiber according to the inventions above, wherein the coupling reaction catalyst contains one or more kinds selected from the group consisting of a carboxylate of an alkali metal, a carboxylate of an alkaline earth metal, a carbonate of an alkali metal, a hydrogen carbonate of an alkali metal, a carbonate of an alkaline earth metal, and a hydrogen carbonate of an alkaline earth metal.

The sixth invention is the method for producing a modified polyester resin reinforced with carbon fiber according to the inventions above, wherein the spreader contains a liquid paraffin.

The seventh invention is a method for producing a molded product of a modified polyester resin reinforced with carbon fiber, comprising reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester by a reactive extrusion method to prepare a modified polyester resin reinforced with carbon fiber having an MFR in accordance with JIS K6760 (at 260° C. and under a load of 2.16 kg) of 20 g/10 minutes or less, and subsequently molding the modified polyester resin reinforced with carbon fiber into a sheet, a board, or a profile extruded product.

The eighth invention is a method for producing a foamed product of a modified polyester resin reinforced with carbon fiber, comprising reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester by a reactive extrusion method to prepare a modified polyester resin reinforced with carbon fiber having an MFR in accordance with JIS K6760 (at 260° C. and under a load of 2.16 kg) of 20 g/10 minutes or less, and subsequently foam-molding the modified polyester resin reinforced with carbon fiber by using a foaming gas of one or more kinds selected from the group consisting of a chemical forming gas, a volatile gas, and an inert gas.

### Advantageous Effects of the Invention

The present invention can provide a method for producing a modified polyester resin reinforced with carbon fiber that has high strength and improved moldability and a method for producing a molded material that has high strength and reduced weight, obtained by molding the modified polyester resin reinforced with carbon fiber into sheets, boards, profile extruded products, pipes, foam, and similar products.

### DESCRIPTION OF EMBODIMENTS

The present invention will be described in detail below. The present invention newly forms an ester linkage including hydroxy groups through a chemical reaction on carboxyl groups at ends of molecules of a thermoplastic polyester involving a cleavage of an epoxy ring in a polyfunctional epoxy compound as a coupling agent in the presence of a catalyst to produce a modified polyester resin having a large molecular weight and high melt viscosity.

### Constituent (A): Thermoplastic Polyester

The thermoplastic polyester of constituent (A) as a main raw material of the present invention is a saturated aromatic polyester. Specific examples of a polyester in this series are, for example: a polyethylene terephthalate (PET), a low-melting point PET where a small amount of an isophthalic acid is copolymerized, a copolymer of an ethylene glycol, a cyclohexanedimethanol and a terephthalic acid (PETG), a polytetramethylene terephthalate, polybutylene terephthalate (PBT), and a polyethylene-2,6-naphthalate (PEN). The polybutylene terephthalate (PBT) is preferable. The polyethylene terephthalate (PET), which is mass-produced and extremely low cost, is especially preferable.

As the (A) thermoplastic polyester, which is the main raw material of the present invention, a polycarbonate (PC; poly-4,4′-isopropylenediphenyl carbonate) obtained by using a bisphenol A as a main raw material in another series is applicable.

These thermoplastic polyesters preferably have an intrinsic viscosity of 0.60 to 1.25 dl/g.

PET, the representative thermoplastic polyester applicable to the present invention, preferably has intrinsic viscosity measured by dissolving the PET into a mixed solvent of 1,1,2,2-tetrachloroethane/phenol (1:1) at 25° C. of 0.60 dl/g or more (for fibers). The intrinsic viscosity is more preferably 0.70 dl/g or more (for sheets), and most preferably 0.80 dl/g or more (for bottles). An intrinsic viscosity of less than 0.60 dl/g makes a coupling reaction difficult even with the present invention, possibly failing to provide excellent mechanical strength to the obtained modified polyester resin reinforced with carbon fiber. The upper limit of the intrinsic viscosity of PET is not especially limited, but is usually 1.1 dl/g or less, and is preferably around 0.80 dl/g at which PET is mass-produced as a bottle and is comparatively inexpensive. The upper limit of the intrinsic viscosity of commercially available PET is 1.25 dl/g; however, the single use of this PET deteriorates the moldability. Therefore, it is preferable to use this PET mixed with a PET having an intrinsic viscosity of 0.60 to 0.80 dl/g for the present invention.

### Constituent (B): Carbon Fiber

With the present invention, the thermoplastic polyester is modified by the reactive extrusion method and the carbon fiber is inserted into an extruder at a high speed by a side feeding method to achieve the mass-production of the modified polyester resin reinforced with carbon fiber. Accordingly, the shape and quality of the carbon fiber inserted into the extruder are extremely important. The carbon fiber is preferably a chopped product (also referred to as a cut fiber or a binding band) produced by bundling the continuous fiber and forming the bundle into a strip shape with a sizing agent. Although the length of the chop is practically 3 mm, 6 mm, and 12 mm, 6-mm length chop is a standard product and is easily inserted at a high speed. The pellet length of a produced resin is usually 3 mm or 6 mm, and the length is industrially determined based on ease of insertion into a single-screw extruder during a molding process.

The carbon fiber as constituent (B) of the present invention preferably has oxygen-containing functional groups, especially carboxyl groups on the surface. A preferable physical property of the carbon fiber used in the present invention is: a specific gravity of 1.5 to 2.2, a fiber diameter of 7 to 18 μm, a tensile strength of 580 to 4,200 MPa, a modulus of elasticity in tension of 35 to 250 GPa, an extension of 0.3 to 3%, and a carbon content by percentage of 95% or more.

The use of a PAN-based industrial product as the carbon fiber is the most preferable. Especially, an inexpensive carbon fiber chop by Zoltek Corporation in the United States of America (Large Tow (LT) PAN-based carbon fiber “Panex35” with 6-mm length by Zoltek Corporation) is especially preferable. Basic physical properties of “Panex35” are: a specific gravity of 1.81, a fiber diameter of 7.2 μm, a tensile strength of 4,137 MPa, a modulus of elasticity in tension of 242 GPa, an extension of 1.5%, a carbon content by percentage of 95%, and Yild of 270 m/kg. Currently, it seems that, aiming to development of applications for automobiles, Zoltek Corporation advances an increase in amount of production to 25,000 t/year and a cost reduction. Different from the conventional production method, the production method by Zoltek Corporation fires the inexpensive PAN-based Large Tow (LT) at a high speed. This possibly leads to the substantial cost reduction in association with the mass-production. Next, a high-performance carbon fiber for aircraft by Toray Industries, Inc., “TORAYCA” T500, T600, and T700 series are also applicable. For example, T008 series, T010 series, and TS12-006 (cut length: 3 to 12 mm), which are cut fibers for industrial application, or TORAYCA milled fiber MLD series (fiber length: 30 to 150 μm) are/is also applicable as a raw material. The basic physical properties of “TORAYCA” are: a specific gravity of 1.76, a fiber diameter of 7 μm, a tensile strength of 3,530 MPa, a modulus of elasticity in tension of 230 GPa, and a carbon content by percentage of 97% or more. Since extremely expensive, “TORAYCA” is a material that will be applied in the future as the application for the present invention. These carbon fiber industrial products generally contain a comparatively large amount of carboxyl groups.

The carbon fiber is also applicable from pitch-based carbon fiber industrial products (obtainable from, for example, KUREHA CORPORATION, Osaka Gas Chemicals Co., Ltd., and Mitsubishi Rayon Co., Ltd.). While these carbon fibers contain a comparatively large amount of functional groups, the strength is slightly low. This is advantageous in that an isotropy can be given to the strength of a molded product. For example, “KRECA” from KUREHA CORPORATION is: a specific gravity of 1.63, a fiber diameter of about 15 μm, a tensile strength of about 800 MPa, a modulus of elasticity in tension of 35 GPa, and a carbon content by percentage of 95% or more. “DONACARBO” from Osaka Gas Chemicals Co., Ltd. is: a specific gravity of 1.6, a fiber diameter of about 13 μm, a tensile strength of about 588 MPa, a modulus of elasticity in tension of about 40 GPa, and a carbon content by percentage of about 97%. Basic physical properties of a chopped fiber of “DIALEAD” from Mitsubishi Rayon Co., Ltd. are: a specific gravity of 1.5 to 2.2, a fiber diameter of 11 μm, a tensile strength of 1,000 to 3,800 MPa, and a modulus of elasticity in tension of 50 to 900 GPa.

As the carbon fiber, a recycled carbon fiber recovered from a carbon fiber-reinforced thermosetting epoxy resin composite material (CFRP) can be preferably used. The carbon fiber-reinforced thermosetting epoxy resin composite material (CFRP) as the raw material is currently obtained from, for example, about 40% of an end material secondary produced during assembling aircraft, chips secondary produced during drilling the composite material, in addition to fishing rods and golf tee. It is expected that a large amount of CFRP will be derived from a scrap from CFRP, which will comprise about 65% of an airframe of large-sized aircraft, in the future.

Also, cut fiber with continuous fiber (cut length: 3 to 12 mm) for bobbin winding recovered as a half-finished product during production of aircraft airframes or similar products has good quality and is extremely inexpensive, and therefore can be used satisfactory.

The recycled carbon fiber, as exemplified in Production Example 1 in the Examples, produced by an electrolytic oxidation treatment or a similar treatment under a control with reactive conditions according to Japanese Patent Application Laid-Open No. 2013-249386 (Sugiyama method from National Institute of Technology, Hachinohe College) to introduce a large number of carboxyl groups can be especially preferably used. The recycled carbon fiber thus produced can be preferably used. The amount of the carboxyl groups in the recycled carbon fiber is usually in a range of 0.01 to 0.20 mmol/g. The range of the amount of the carboxyl groups in the recycled carbon fiber preferably applicable in the present invention is 0.02 to 0.15 mmol/g.

The fiber length of the recycled carbon fiber depends on the dimension of the CFRP end material of, for example, an aircraft, etc., and the size of chips when boring during assembling aircraft. The present invention designates a fiber length of 100 mm or more as a long fiber, a fiber length of 3 to 100 mm as a medium fiber, and a fiber length of 3 mm or less as a powdered fiber. All carbon fibers are preferably applicable to the present invention.

As described above, the present invention can preferably use recycled carbon fiber from inexpensive industrial carbon fiber, less expensive recovered carbon fiber, and the carbon fiber-reinforced composite material (CFRP) from aircraft end material. One kind of carbon fiber may be used alone, or two or more kinds of carbon fibers may be used in combination.

The blending amount of the carbon fiber as constituent (B) is 5 to 150 parts by weight with respect to 100 parts by weight of the thermoplastic polyester as constituent (A). A blending amount of less than 5 parts by weight suggests the insufficient strength of the molded product. An excess of 150 parts by weight makes it difficult to produce the resin pellets.

### Constituent (C): Coupling Agent

As the coupling agent of constituent (C) in the present invention, a high-molecular polyfunctional epoxy compound having a weight-average molecular weight of 2,000 to 10,000 and two or more or preferably 2 to 100 epoxy groups in the molecules is applicable. Only one kind of the polyfunctional epoxy compound may be used, or two or more kinds of the polyfunctional epoxy compounds may be used in combination. A commercial product containing glycidyl groups including an epoxy ring suspended like a pendant and epoxy groups in a molecule in a resin forming a frame of the high molecular weight, for example, “MARPROOF” series from NOF CORPORATION and “JONCRYL ADR” series from BASF Japan Co., Ltd. can be preferably used. As the resin becoming the frame, an acrylic resin base and a styrene acrylic resin base are more preferable than the polyolefin base (PP, PS, PE). This is because, solubility parameters of the resin are: a raw material PET of 10.7, an epoxy resin of 10.8, a polymethyl acrylate of 10.2, a polyethyl acrylate of 9.4, a polypropylene (PP) of 9.3, a polyethyl methacrylate of 9.0, a polystyrene (PS) of 8.9, and a polyethylene (PE) of 8.0. The closer the value is, the better the mixture is.

The mixture of the polyolefin base by only 1 to 2% clouds a PET-based resin film/sheet, thereby being inappropriate when transparency is required for the molded product. However, the polyolefin base is applicable to an application not requiring transparency and a black molded product.

The blending amount of the polyfunctional epoxy compound as constituent (C) is 0.1 to 2 parts by weight with respect to 100 parts by weight of the polyester as constituent (A). The blending amount of constituent (C) is appropriately set according to the kind of constituent (C) and the kind and the additive amount of the carbon fiber as constituent (B) in the above-described range. Generally, a blending amount of less than 0.1 part by weight results in an insufficient effect of the increase in molecular weight and melt viscosity. This also makes the moldability insufficient, deteriorating the basic physical properties and the mechanical properties of the molded product. An excess of 2 parts by weight conversely deteriorates the moldability, resulting in yellowing and coloring of the resin and secondary production of a gel and fisheye (FE).

### Constituent (D): Coupling Reaction Catalyst

The coupling reaction catalyst as constituent (D) in the present invention is a catalyst containing one or more kinds selected from the group consisting of (1) an organic acid salt, a carbonate, and a hydrogen carbonate of alkali metal and (2) an organic acid salt, a carbonate, and a hydrogen carbonate of an alkaline earth metal. Although as the organic acid salt, for example, a carboxylate and an acetate are applicable, a stearate is especially preferable among the carboxylates. As a metal forming a metal salt of the carboxylic acid, an alkali metal such as lithium, sodium, and potassium; and an alkaline earth metal such as magnesium, calcium, strontium, and barium are applicable.

The blending amount of the carboxylate as this coupling reaction catalyst is 0.01 to 1 part by weight with respect to 100 parts by weight of the polyester as constituent (A) and is preferably 0.1 to 0.5 part by weight. A blending amount of less than 0.01 part by weight brings a small effect as the catalyst and fails to cause a copolymerization reaction, possibly resulting in insufficient increase in molecular weight. An excess of 1 part by weight causes a failure in an extrusion molding machine or a similar failure due to gel generated by local reaction and a sudden increase in melt viscosity by promotion of hydrolysis.

The present invention can use the coupling agent as constituent (C) and the coupling reaction catalyst as constituent (D) in the form of a masterbatch whose base is a resin that contains any of one or more kinds of the group consisting of an amorphous polyester or a polyolefin. Actual examples are exemplified in Production Example 2 and Production Example 3.

### Constituent (E): Spreader

The spreader as constituent (E) in the present invention is especially effective in the case where the thermoplastic polyester as constituent (A) and the carbon fiber as constituent (B) are powders. As the spreader of constituent (E), for example, a paraffin oil, a liquid paraffin, and a trimethylsilane are applicable. The liquid paraffin is nonpolar, has a high boiling point, and is appropriate adhesive fluid and therefore is especially preferable. The blending amount of the spreader as constituent (E) is 0.01 to 1 part by weight with respect to 100 parts by weight of the thermoplastic polyester as constituent (A). The spreader (E) is required to uniformly attach the carbon fiber as constituent (B) to the pellets or powder of the thermoplastic polyester as constituent (A). Additionally, the spreader (E) is an indispensable auxiliary agent to prevent the powder from flying in the atmosphere and adversely affecting humans and electrical instrumentation equipment.

The present invention can use a generally-known conventional foaming agent. For example, as a volatile blowing agent, a carbon dioxide gas and/or a nitrogen gas as an inert gas can be used. These gases do not cause fires and do not require a explosion-proof apparatus, thereby can be operated in small factories for small and medium enterprises. The gases are appropriate for industrial production of the foam with low foaming ratio of the present invention.

As the foaming agent, a heat decomposable blowing agent is applicable. Since the melting point of the polyester resin exceeds 200° C., there are not too many chemical substances that are actually applicable. A baking soda-based foaming agent used for low foaming of polypropylene is applicable. However, since the foaming agent involves generation of water vapor, this requires short-term apparatus maintenance for the foam forming of a polyester resin, which is likely to hydrolyze.

As the foaming agent, a low-boiling point hydrocarbon-based compound, for example, propane, butane, and hexane are applicable. The foaming agent is appropriate for high foaming ratios of 5 to 20 times. However, since the strength of the foam decreases sharply in association with the increase in foaming ratio, this leaves the problem. Handling of an inflammable gas requires protection of facilities and buildings against explosion, thereby leaving the problem that the inflammable gas can be operated only by large-scale companies.

In the present invention, the pellets of the modified polyester resin reinforced with carbon fiber having a melt flow rate in accordance with JIS K6760 (at 260° C. and under a load of 2.16 kg) of 20 g/10 minutes or less can be manufactured at high speed while reducing a strand cut. However, in the case where the melt viscosity tends to be insufficient by a foaming method with a horizontal extrusion method, the molding stability is poor. Therefore, the present invention preferably uses the coupling agent as constituent (C) and the coupling reaction catalyst as constituent (D) as it is during the molding process or uses constituent (C) and constituent (D) in the form of the masterbatch whose base is the resin containing one or more kinds selected from the group consisting of the amorphous polyester or the polyolefin together during the foam-molding process. The additive amount of the masterbatch is 1 to 10 parts by weight with respect to 100 parts by weight of the modified polyester resin reinforced with carbon fiber and is preferably 2 to 6 parts by weight. In an extrusion foam molding, the use of the pellets of the modified polyester resin reinforced with carbon fiber whose melt flow rate (at 260° C. and under a load of 2.16 kg) in accordance with JIS K6760 is 0.1 to 20 g/10 minutes is preferable.

### Combination Method and Reactive Extrusion Method

The following describes the method for combining the polyester resin of the present invention. The thermoplastic polyester as constituent (A) with any given shape of normal virgin pellets, recovered flakes, granular matter, powder, chips, or a similar shape is applicable. Drying the polyester, the main constituent, is generally preferable. The constituents are each mixed with a mixer such as a tumbler and a Henschel mixer and then are supplied to an extruding machine by top feed method. This method is appropriate for the powder carbon fiber. It is only necessary that a temperature for heating and melting is equal to or more than the melting point of the thermoplastic polyester. However, from the aspect of the reactive extrusion method, 250 to 300° C. is desirable. Especially, the temperature for heating and melting is preferably 280° C. or less and is more preferably 265° C. or less. An excess of 300° C. possibly degenerates a surface treatment agent and the sizing agent of the carbon fiber and discolors and pyrolyzes the polyester.

Except for the above-described method of simultaneous mixture, as the side feeding method, while the polyester as constituent (A), the coupling agent as constituent (C), the coupling reaction catalyst as constituent (D), and the spreader as constituent (E) are supplied to a twin-screw extruder for the reactive extrusion, the carbon fiber as constituent (B) is injected to an outlet exit part of the twin-screw extruder. This ensures producing the composite material while preventing the carbon fiber from being cut. This method is appropriate for the short carbon fiber.

As the reactive extruder, a single-screw extruder, twin-screw extruder, two-stage extruder as a combination of the single-screw extruder and the twin-screw extruder, and similar extruders are applicable. Single-screw extruders are inexpensive and appropriate for the powder carbon fiber. Although expensive, twin-screw extruders are appropriate for the side feeding of the short carbon fiber.

As the application examples of the high-strength, lightweight low foamed product of the present invention, residential outdoor deck material and marine structure material are assumed for the time being. Especially, the amount of residential outdoor deck material used in the United States of America and the Europe reaches 2,600,000 tons a year. The materials conventionally depend on natural woods; however, South Sea wood and South America wood encounter face resource depletion, thereby lacking an outlook for recovery. Currently, synthetic woods of wood flour/polyethylene and wood flour/polypropylene are used. However, compared with the high strength of natural wood (flexural modulus: 6 to 14 GPa), the strengths of the synthetic woods of the wood flour/polyethylene (1 to 3 GPa) and the wood flour/polypropylene (about 5 GPa) are too weak. Meanwhile, the market for synthetic wood in North America is about 690000 tons/2013 in which wood flour/polyethylene constitutes 83%, wood flour/polypropylene constitutes 9%, wood flour/vinyl chloride constitutes 7%, and others constitute 1%.

Since the modified polyester resin reinforced with carbon fiber of the present invention has large strength as a solid molded product (a flexural modulus of 22 GPa in combination with 30% by weight of the carbon fiber produced by Zoltek Corporation), the development of a molded product obtained by foaming the resin at the low foaming ratio is expected.

### EXAMPLES

The present invention will be explained in detail based on examples. Evaluation methods for the thermoplastic polyester and the modified polyester resin reinforced with carbon fiber (composite material) are as follows.

### (1) Method for Measuring Intrinsic Viscosity (IV Value) of, for Example, PET

A mixed solvent of 1,1,2,2-tetrachloroethane and a phenol by equal weight was used to measure the intrinsic viscosity with a Cannon-Fenske viscometer at 25° C. Alternatively, catalog values of the manufacturers were used.

### (2) Method for Measuring Melt Flow Rate (MFR)

In accordance with condition 20 in JIS K7210, the melt flow rate was measured under conditions of a temperature at 280° C. or a temperature at 260° C. and under a load of 2.16 kg. Note that, a resin preliminary dried by hot air or dried by vacuum for 120° C.×12 hours or 140° C.×4 hours was used.

### (3) Method for Measuring Specific Gravity

In accordance with the method A in JIS K7112 (underwater substitution method), a resin pellet or a small piece of a molded product was measured with alcohol as liquid. Alternatively, the specific gravity was measured also by the dimension measurement method in JIS K7222.

### (4) Method for Measuring Mechanical Strength

(4-1) With a small amount of experimental pellets, a small-size specimen was created for the measurement.

For example, an injection molding machine produced by Sumitomo Heavy Industries, Ltd., SE18DUZ (a mold clamping pressure of 18 tons and a screw diameter of 16 mm) was used for molding under conditions of a molding temperature of 270° C., a molding temperature of 35° C., and a cooling period of 15 to 20 seconds.

Shapes of specimen: tensile specimen (JIS K7162 5 A, thickness: 2 mm)
: bending specimen (strip, 80 mm×10 mm×thickness 4 mm)

(4-2) With a large amount of experimental pellets (3 kg or more), a multipurpose specimen was created for the measurement.

Shape of specimen: ISO 20753 (JIS K7139, A1), overall length: 120 mm, thickness: 4 mm, width of chuck portion: 20 mm, width of narrowed portion: 10 mm, length of narrowed portion: 80 mm (Z-runner method molding method)

Tensile test: The tensile strength was conducted at a test speed of 2 mm/minutes and was evaluated with an average value of 3 to 5 points. The Young's modulus was calculated by linear regression with a maximum load of 25% and 75% (JIS K7073 and similar specifications).

Bending test: Three-point bending was performed at a test speed of 5 mm/minutes to evaluate the bending strength with an average value of 3 to 5 points. The flexural modulus was calculated by linear regression with a maximum load of 25% and 75% (JIS K7074 and similar specifications).

(5) Method for Measuring Amount of Acidic Functional Groups and Amount of Carboxyl Groups

In accordance with JIS K0070, the amounts were measured by a Boehm method. Sodium hydroxide and sodium hydrogen carbonate were individually added to a sample of a carbon fiber or a polyester. With a potential difference automatic measurement device, back titration was performed a using hydrochloric acid solution. All amounts of the acidic functional groups (all amounts of acid) were measured by back titration with the hydrochloric acid solution after the addition of the sodium hydroxide. The amount of a strongly acidic functional group (an amount of the carboxyl group) was measured by back titration with the hydrochloric acid solution after the addition of the sodium hydrogen carbonate. The amount of weakly acidic functional groups (amount of phenol-based hydroxyl group) was obtained from: total amount of acid—amount of carboxyl groups. For example, the amount of the carboxyl groups is 0.01 to 0.15 mmol/g at a surface of a carbon material on a negative electrode of a cell and 0.04 mmol/g or less in the polyethylene terephthalate (PET).

The following describes production examples of characteristic materials related to the present invention. For adhesion with the thermoplastic polyester and coupling reactivity with a modifier, the carbon fiber as constituent (B) preferably contains the acidic functional groups and the carboxyl groups. The new industrial product also contains the acidic functional groups and the carboxyl groups more or less.

### Production Example 1

### Production Example of Recycled Carbon Fiber as Constituent (B) that has Acidic Functional Group and Carboxyl Group

### [Production Example by Firing Method of Recycled Carbon Fiber and Electrolytic Oxidation Method of Alkaline Solution, and Analysis Example]

In accordance with Japanese Patent Application Laid-Open No. 2013-249386 (Sugiyama method from National Institute of Technology, Hachinohe College), about 30 kg of the end material of CFRP secondary produced during aircraft assembly was cut out to 10-cm square or less. A thermosetting epoxy resin part was fired and removed with an electric furnace at 400 to 500° C. to obtain about 15 kg of the recycled carbon fiber (aggregate).

5 g of the recycled carbon fiber (aggregate) was put into a 500-cc beaker to immerse the recycled carbon fiber into 200 mL of 0.1 mol/L of a sodium hydroxide aqueous solution. Designing the recycled carbon fiber aggregate side as an anode and a cathode side as a titanium electrode, a DC electrolytic reaction was performed for one hour at 3 V×0.5 A. The recycled carbon fiber opened by this electrolytic oxidation treatment was water-cleaned until becoming neutrality and was dried for storage. This process was repeated three times.

1 g of the recycled carbon fibers were measured in each 200-cc conical flask and were immersed into 50 mL of 0.1 mol/L of a sodium hydroxide aqueous solution or 50 mL of 0.1 mol/L of a sodium hydrogen carbonate aqueous solution. After being plugged, the two materials were applied to a 24-hour osmosis machine. 5 mL of a supernatant from each container was titrated with 0.05 mol/L of a hydrochloric acid aqueous solution and the total amount of acid and the amount of the carboxyl groups were identified. This analysis by the Boehm method was also performed on the recycled carbon fiber after the firing and the new carbon fiber. Table 1 shows the results.

TABLE 1

| | Recycled carbon | | |
|---|---|---|---|
| | fiber after | Recycled carbon | New |
| Analysis by | electrolytic | fiber after | carbon |
| Boehm method | oxidation | firing | fiber |
| Total amount | 0.16 | 0.04 to 0.06 | 0 |
| of acid (mmol/g) | | | |
| Amount of carboxyl | 0.10 | 0.03 to 0.05 | 0.01 |
| groups (mmol/g) | | | |

Although the extremely trace amounts of the carboxyl groups were present in the new carbon fiber, 0.03 to 0.05 mmol/g of the carboxyl groups was present in the recycled carbon fiber after the firing of the present invention, and the recycled carbon fiber after the electrolytic oxidation increased the carboxyl groups up to 0.10 mmol/g, two to three times that of the recycled carbon fiber after the firing. Since the amount of the carboxyl groups in the polyethylene terephthalate (PET) is 0.04 mmol/g or less, the amount of the carboxyl groups in the recycled carbon fiber is sufficient.

About 1 kg of the recycled carbon fiber aggregate obtained above was put into 10 L of an electrolyzer to form a potassium hydroxide aqueous solution. This recycled carbon fiber aggregate was designed as the anode side made of copper, and the cathode side was designed as the electrode made of titanium, and a low-current/low-voltage DC electrolytic reaction was performed for four hours. Although the most of the recycled carbon fiber aggregate was open, the recycled carbon fiber aggregate was further mechanically opened to obtain recycled carbon fiber with black gloss. The fiber length was 5 to 10 cm. An alkaline aqueous solution containing about 50% by weight of the recycled carbon fiber was neutralized with acidic solution, was water-cleaned, and dried at 180° C. for one night for storage. A similar operation was repeated several times to produce 5 kg of recycled carbon fiber.

### Production Example 2

### Modifier Masterbatch of Constituent (C) and Constituent (D) (MB-G)

### [Production Example of Modifier Masterbatch of Constituent (C) and Constituent (D) (MB-G) Using PETG as Base Resin]

The modifier masterbatch (MB-G) is usually constituted of a combination of the coupling agent masterbatch as constituent (C) and the coupling reaction catalyst masterbatch as constituent (D) on a one-on-one basis of these pellets.

### [1] Production Example of Masterbatch of Coupling Agent as Constituent (C)

For the coupling agent of constituent (C), as a representative example of the polyfunctional epoxy compound having two or more epoxy groups in the molecule, “MARPROOF G-0130SP” from NOF CORPORATION (the number of epoxies: 10/molecule, number-average molecular weight: 5,500, equivalence of epoxy: 530 g/eq., white powder) was employed and as the base resin, an amorphous copolyester from Eastman Chemical Company, “Eastar PETG 6763” was used.

First, 115.1 kg of a composition constituted of 15 kg of MARPROOF G-0130SP, 50 kg of a pulverized white powder of Eastar PETG 6763 as the base resin, 50 kg of transparent pellets of Eastar PETG 6763, and 0.10 kg of a liquid paraffin as the spreader were mixed with a Henschel mixer.

Using a codirectional twin-screw extruder produced by TOSHIBA MACHINE CO., LTD. (screw bore: 70 mm, L/D=32, two-vent type), cylinder and die temperatures were set to 100 to 220° C. and the number of screw rotations was set to 160 rpm. 115 kg of the composition was top-fed from a hopper through a constant-amount feeder. A resin pressure of a strand mold was 4.9 to 5.0 MPa, the strand from an outlet of the mold into a basin was linearly stabilized, and discharge speed was 117 kg/h.

After this, the warm white pellets A (the masterbatch of the coupling agent as constituent (C)) were immediately transported to the hopper at 70° C. and fluidized drying was performed for one night, the white pellet A was stored in a three-layer moistureproof bag made of paper, aluminum, and polyethylene. Yield was 107 kg.

### [2] Production Example of Masterbatch of Coupling Reaction Catalyst as Constituent (D)

As a representative example of the coupling reaction catalyst, 110.2 kg of a composition constituted of 10 kg of a white powder composite catalyst (abbreviated as “010”) consisting of 50% by weight of a calcium stearate, 25% by weight of a lithium stearate and 25% by weight of a sodium stearate, 50 kg of a pulverized white powder of PETG 6763 as the base resin, 50 kg of a transparent pellet of PETG 6763, and 0.20 kg of a liquid paraffin as the spreader were mixed with a Henschel mixer. This composition was introduced into the hopper on the extruder. The extrusion was performed by operations almost similar to [1]. The resin pressure of the strand mold was 7.1 to 9.6 MPa, the white strand from the outlet of the mold into the basin was linearly stabilized, and discharge speed was 200 kg/h.

After this, the warm white pellets B (the masterbatch of the coupling reaction catalyst as constituent (D)) were immediately transported to the hopper at 70° C. and the fluidized drying was performed for one night, the white pellet B was stored in a three-layer moistureproof bag made of paper, aluminum, and polyethylene. Yield was 102 kg.

100 kg of the white pellets of the coupling agent masterbatch A as constituent (C) and 100 kg of the white pellets of the coupling reaction catalyst masterbatch B as constituent (D) were combined to produce 200 kg of the modifier masterbatch (MB-G).

### Production Example 3

### Modifier Masterbatch of Constituent (C) and Constituent (D) (MB-E)

### [Production Example of Modifier Masterbatch of Constituent (C) and Constituent (D) (MB-E) Using Polyethylene as Base]

The modifier masterbatch (MB-E) is usually constituted of a combination of the coupling agent masterbatch as constituent (C) and the coupling reaction catalyst masterbatch as constituent (D) on a two-on-one basis of these pellets.

### [1] Production Example of Coupling Agent Masterbatch as Constituent (C)

A composition obtained by mixing 116 kg of a composition constituted of 15 kg of MARPROOF G-0130SP, 100 kg of a pulverized low-density polyethylene (melt index (MI): 2 g/10 minutes at 190° C. and under a load of 2.16 kg) as the base resin, and 1 kg of a talc as a crystal nucleating agent with a Henschel mixer was used. Otherwise, the composition was produced similar to Production Example 2.

After this, the warm white pellets AE (the coupling agent masterbatch as constituent (C)) were immediately transported to the hopper at 70° C. and the fluidized drying was performed for one night, the white pellet AE was stored in a three-layer moistureproof bag made of paper, aluminum, and polyethylene. Yield was about 100 kg.

### [2] Production Example of Coupling Reaction Catalyst Masterbatch as Constituent (D)

A composition obtained by mixing 110 kg of a composition constituted of 10 kg of a white powder composite catalyst 010 and 100 kg of a pulverized low-density polyethylene (melt index (MI): 2 g/10 minutes at 190° C. and under a load of 2.16 kg) as the base resin with a Henschel mixer was used. Otherwise, the composition was produced similar to Production Example 2.

After this, the warm white pellets BE (the coupling reaction catalyst masterbatch as constituent (D)) were immediately transported to the hopper at 70° C. and the fluidized drying was performed for one night, the white pellet BE was stored in a three-layer moistureproof bag made of paper, aluminum, and polyethylene. Yield was about 100 kg.

100 kg of the white pellet of the coupling agent masterbatch AE as constituent (C) and 50 kg of the white pellet of the coupling reaction catalyst masterbatch BE as constituent (D) were combined to produce 150 kg of the modifier masterbatch (MB-E).

### Example 1

### Production of Pellets R1 of Modified Polyethylene Terephthalate Reinforced with Carbon Fiber Consisting of Polyethylene Terephthalate, 15% by Weight of Carbon Fiber Chop (6-Mm Length) Produced by Zoltek Corporation and Modifier

As the thermoplastic polyester of constituent (A), 100 parts by weight of general-purpose polyethylene terephthalate pellets (bottle grade: Taiwan, NAN YA 3802T, IV value: 0.80) (content of water content after drying: about 100 ppm or less), as the coupling agent of constituent (C), 0.60 part by weight of a multifunctional epoxy resin (“MARPROOF G-0130SP” from NOF CORPORATION: the number of epoxies of 10/molecule, the number average molecular weight of 5,500, and the equivalence of epoxy of 530 g/eq.), as the coupling reaction catalyst of constituent (D), 0.16 part by weight of the white powder composite catalyst 010, and as the spreader of constituent (E), 0.06 part by weight of the liquid paraffin were uniformly mixed with a super mixer. These constituents were introduced into a first hopper for main resin extrusion. Meanwhile, as the carbon fiber of constituent (B), a PAN-based carbon fiber from rayon: LT carbon fiber chop (Large Tow (LT) from Zoltek Corporation in the United States of America) “Panex35 (Type-95)” (6 mm-length chop, the sizing agent: 2.75%, the water content: 0.20%) was introduced into a second hopper for side feeder.

Using a codirectional twin-screw extruder produced by TOSHIBA MACHINE CO., LTD. (screw bore: 60 mm, one-vent type), temperatures of cylinders and dies constituted of 10 blocks of this extruder were set to 150 to 280° C., and the number of screw rotations was set to 150 rpm. Using a weight type measurement feeder, a reactive extrusion was performed on a mixed resin of constituent (A), constituent (C), constituent (D), and constituent (E) at a speed of 100 kg/h from the first hopper. Additionally, the carbon fiber chop was continuously side-fed at a speed of 17.6 kg/h (the carbon fiber content of 15% by weight) from the second hopper.

The strand was continuously extruded from a nozzle with a bore of 3 mm in an obliquely downward direction into water. The strand was cut off by a rotary cutter to produce about 180 kg of the black resin pellets R1. The strand from the mold outlet into the basin was linear, and the melt tension was increased. The shape was cylindrical with a diameter of about 3.4 mm×length of about 6 mm. The MFR (at 260° C. and under a load of 2.16 kg) was 6.2 g/10 minutes.

These black pellets R1 of the modified polyethylene terephthalate reinforced with carbon fiber were dried by hot air at 120° C. for one night. Using a hybrid injection molding machine FNZ60 produced by NISSEI PLASTIC INDUSTRIAL CO., LTD. (mold clamping pressure of 140 tons and a screw diameter of 60 mm), the following injection-molded product was molded under conditions of a molding temperature of 280° C., a mold temperature of 130 to 145° C., an injection pressure of 53 MPa, an injection speed of 12 mm/s, the number of screw rotations of 80 rpm, and a cooling period of 20 seconds.

Shape of multipurpose specimen: ISO 20753 (JIS K7139, A1), overall length: 120 mm, thickness: 4 mm, width of chuck portion: 20 mm, width of narrowed portion: 10 mm, length of narrowed portion: 80 mm (Z-runner method molding method)

These pellets R1 of the modified polyethylene terephthalate reinforced with carbon fiber (15% by weight of CF) produced by Zoltek Corporation exhibited satisfactory injection moldability without the generation of burrs. The surface of the specimens were smooth and shiny. The test was conducted at a tension speed of 2 mm/minute and a bending speed of 5 mm/minute. Table 2 shows the physical values of these pellets.

Compared with the transparent pellets P1 of Comparative Example 1, which were made only of the polyethylene terephthalate, the effects of these R1 in which about 15% weight of the carbon fiber produced by Zoltek Corporation was mixed were: 2.9 times the tensile strength, 4.1 times the Young's modulus, 3.5 times the bending strength, and 5.7 times the flexural modulus.

### Example 2

### Production of Pellets R2 of Modified Polyethylene Terephthalate Reinforced with Carbon Fiber Consisting of Polyethylene Terephthalate, 30% by Weight of Carbon Fiber Chop (6-Mm Length) Produced by Zoltek Corporation, and Modifier

The pellets R2 were produced under conditions almost identical to Example 1. Note that, to achieve about 30 wt. % content of the carbon fiber chop, the speed of the side-feed was sped up 2.4 times.

As the polyester of constituent (A), 100 parts by weight of general-purpose polyethylene terephthalate pellets (bottle grade: Taiwan, NAN YA 3802T, IV value: 0.80) (content of water content after drying: about 100 ppm or less), as the coupling agent of constituent (C), 0.56 part by weight of a multifunctional epoxy resin, as the coupling reaction catalyst of constituent (D), 0.16 part by weight of a white powder composite catalyst C10, and as the spreader of constituent (E), 0.06 part by weight of a liquid paraffin were uniformly mixed with a super mixer. These constituents were introduced into the first hopper for main resin extrusion. Meanwhile, as the carbon fiber of constituent (B), an LT carbon fiber chop (Large Tow (LT) from Zoltek Corporation in the United States of America PAN-based carbon fiber, “Panex35” with 6-mm length) was introduced into the second hopper for side feeder.

Using a codirectional twin-screw extruder (screw bore: 60 mm, one-vent type), temperatures of the cylinders and the dies constituted of 10 blocks of this extruder were set to 150 to 270° C., and the number of screw rotations was set to 150 rpm. Using the weight type measurement feeder, the reactive extrusion was performed on a mixed resin of constituent (A), constituent (C), constituent (D), and constituent (E) at a speed of 100 kg/h from the first hopper. Additionally, the carbon fiber chop was continuously side-fed at a speed of 42 kg/h (the carbon fiber content of 30% by weight) from the second hopper.

The strand was continuously extruded from the nozzle with the bore of 3 mm in the obliquely downward direction into water. The strand was cut off by the rotary cutter to produce about 250 kg of the black resin pellets R2. The strand from the mold outlet into the basin was linear, and the melt tension was increased.

The shape was cylindrical with a diameter of about 3.4 mm×length of about 6 mm. The MFR (at 260° C. and under a load of 2.16 kg) was 6.7 g/10 minutes. These pellets R2 of the modified polyethylene terephthalate reinforced with carbon fiber (15% by weight of CF) exhibited satisfactory injection moldability without the generation of burrs. The surface of the specimens were smooth and shiny. Table 2 shows the physical values of these pellets.

Compared with the transparent pellets P1 of Comparative Example 1, which were made only of the polyethylene terephthalate, the effects of these R2 in which 30% by weight of the carbon fiber produced by Zoltek Corporation was mixed were: 3.5 times the tensile strength, 6.1 times the Young's modulus, 3.9 times the bending strength, and 10.3 times the flexural modulus. Thus, the pellets of the modified polyethylene terephthalate reinforced with carbon fiber having satisfactory injection moldability and substantially improved mechanical strength were obtained.

TABLE 2
Physical properties of modified polyethylene terephthalate (pellets)
reinforced with carbon fiber produced by Zoltek Corporation

| | Example number | | |
|---|---|---|---|
| | (pellet designation) | | |
| | Comparative | | |
| | Example 1 | Example 1 | Example 2 |
| | (P1) | (R1) | (R2) |
| Content of carbon fiber | 0 | 15 | 30 |
| produced by Zoltek | | | |
| Corporation (wt. %) | | | |
| Pellet shape: | About | About | About |
| diameter × length (mm) | 2.5 × 3.5 | 3.4 × 6 | 3.4 × 6 |
| MFR at 260° C. and | 16 | 6.2 | 6.7 |
| under a load of 2.16 kg | | | |
| (g/10 min.) | | | |
| Tensile strength (MPa) | 59 | 171 | 209 |
| Young's modulus (GPa) | 1.9 | 7.70 | 11.6 |
| Bending strength (MPa) | 84 | 291 | 331 |
| Flexural modulus (GPa) | 2.1 | 12.0 | 21.7 |
| Thermal distortion | 65 | 212 | 223 |
| temperature under a | | | |
| load of 1.80 MPa (° C.) | | | |
| Specific gravity | 1.35 | 1.39 | 1.45 |

### Example 3

### Production of Pellets R3 of Modified Polyethylene Terephthalate Reinforced with Recovered Carbon Fiber, Consisting of Polyethylene Terephthalate, about 15% by Weight of Recovered Carbon Fiber Chop (6-Mm Length) and Modifier Masterbatch

As the polyester of constituent (A), 120 kg of commercially available polyethylene terephthalate (PET) pellets (general-purpose bottle grade: the water content after dried by hot air at 120° C. for 12 hours: about 100 ppm, IV value: 0.80, MFR (at 260° C. and under a load of 2.16 kg): 10 g/10 minutes) and 7.2 kg of the modifier masterbatch (MB-G in Production Example 2) were mixed at 30 rpm×10 minutes using a tumbler. These constituents were introduced into the first hopper.

As the carbon fiber as constituent (B), 40 kg of a recovered carbon fiber chop (a product left after a use of a bobbin winding: 6-mm length chop made of a PAN-based carbon fiber where a grade equivalent to “TORAYCA” T700 was recovered, no sizing agent) was introduced into the second hopper.

Using a codirectional twin-screw extruder produced by Berstorff in Germany (ZE40E, screw bore: 42 mm, UD=38), temperatures of cylinder and dies constituted of 10 blocks of this extruder were set to 150 to 270° C., and the number of screw rotations was set to 100 rpm. The recovered carbon fiber chop was continuously injected into a fifth block.

Using a weight type measurement single-axis feeder, the PET as constituent (A) and the modifier masterbatch pellet of constituent (C) and constituent (D) (MB-G in Production Example 2) were introduced from the first hopper at a speed of 18.02 kg/h, and the recovered carbon fiber chop was introduced at a speed of 3.0 kg/h (the carbon fiber content of 14.3% by weight) from the second hopper into the extruder.

The three strands were continuously extruded from the nozzle with the bore of 3 mm in the obliquely downward direction into water. The strands were cut off by the rotary cutter at a taking-in speed of 20 m/minutes to produce black resin pellets R3. The resin pressure of the strand mold was 0.90 to 1.2 MPa. The strand from the mold outlet into the basin was linear, and the melt tension was increased.

After this, the warm black resin pellets (yield of 20.6 kg) R3 were immediately dried by hot air at 120° C. for one night, the black resin pellets R3 were stored in a three-layer moistureproof bag made of paper, aluminum, and polyethylene. The shape was cylindrical with the diameter of about 2.5 mm×length of about 4.5 mm. The MFR (under a load of 2.16 kg) was 10 g/10 minutes (at 260° C.) and 35 g/10 minutes (at 280° C.).

These black pellets R3 of the modified polyethylene terephthalate reinforced with recovered carbon fiber (15% by weight) were dried again under vacuum. Using an injection molding machine SE18DUZ produced by Sumitomo Heavy Industries, Ltd. (the mold clamping pressure of 18 tons and the screw diameter of 16 mm/SL screw), the following injection-molded product was molded under conditions of the molding temperature of 270 to 280° C., the mold temperature of 37 to 38° C., the injection pressure of 64 to 70 MPa, the injection speed of 20 mm/s, the number of screw rotations of 100 rpm, and the cooling period of 15 seconds.

Shape of injection-molded product: small piece for tensile test (JIS K7162, 5 A, thickness of 2 mm)

Although under almost similar conditions, using the identical molding apparatus, the following injection-molded product was molded under conditions of an injection pressure of 115 to 123 MPa and a cooling period of 20 seconds.

Shape of injection-molded product: small piece for bending test (strip, length 80 mm×width 10 mm×thickness 4 mm)

Both exhibited satisfactory injection moldability without the generation of burrs. Table 3 shows the physical values of these pellets R3. Compared with the transparent pellets P1 of Comparative Example 1, which were made only of the polyethylene terephthalate, the pellets R3 were: 2.0 times the tensile strength, 2.1 times the Young's modulus, 2.3 times the bending strength, and 3.9 times the flexural modulus.

### Example 4

### Production of Pellets R4 of Modified Polyethylene Terephthalate Reinforced with Recovered Carbon Fiber, Consisting of Polyethylene Terephthalate, about 30% by Weight of Recovered Carbon Fiber Chop (6-Mm Length) and Modifier Masterbatch

The pellets R4 were produced under conditions almost identical to Example 3. Note that, to achieve about 30 wt. % content of the recovered carbon fiber chop, the supply speed was sped up 2 times, and the supply velocities of the PET and the MB-G were reduced. That is, 67.2 parts by weight of commercially available polyethylene terephthalate pellets as constituent (A) and 4.0 parts by weight of the modifier masterbatch of constituent (C) and constituent (D) (MB-G in Production Example 2) were mixed for 10 minutes at 30 rpm using the tumbler. These constituents were introduced into the first hopper. As the carbon fiber of constituent (B), a recovered carbon fiber chop (produced by collecting recovered products of a PAN-based carbon fiber of a bobbin winding and cutting the product into 6-mm length, 40 kg) was introduced into the second hopper.

Using a codirectional twin-screw extruder produced by Berstorff in Germany (ZE40E, screw bore: 42 mm, L/D=38), temperatures of cylinders and dies constituted of 10 blocks of this extruder were set to 150 to 270° C., and the number of screw rotations was set to 150 rpm. The recovered carbon fiber chop was continuously injected into the fifth block.

Using the weight type measurement single-axis feeder, the PET as constituent (A) and the modifier masterbatch pellets of constituent (C) and constituent (D) (MB-G in Production Example 2) were introduced from the first hopper at a speed of 14.84 kg/h, and the recovered carbon fiber chop was introduced at a speed of 6.0 kg/h (the carbon fiber content of 28.8% by weight) from the second hopper into the extruder.

The three strands were continuously extruded from the nozzle with the bore of 3 mm in the obliquely downward direction into water. The strands were cut off by the rotary cutter at the taking-in speed of 20 m/minutes to produce the black resin pellets R2. The resin pressure of the strand mold was 1.1 to 1.2 MPa. The strand from the mold outlet into the basin was linear, and the melt tension was increased.

After this, 65 kg of the warm black resin pellets R4 were immediately dried by hot air at 120° C. for one night, the black resin pellets R4 were stored in a three-layer moistureproof bag made of paper, aluminum, and polyethylene. The shape was cylindrical with the diameter of about 3 mm×length of about 5 mm. The MFR (under a load of 2.16 kg) was 7.0 g/10 minutes (at 260° C.) and 25 g/10 minutes (at 280° C.).

These black pellets R4 were dried again under vacuum. Although conditions were almost similar to Example 3, using the injection molding machine SE18DUZ produced by Sumitomo Heavy Industries, Ltd. (the mold clamping pressure of 18 tons and the screw diameter of 16 mm/SL screw), the following injection-molded product was molded under the condition of the injection pressure of 116 to 121 MPa.

Shape of injection-molded product: small piece for tensile test (JIS K7162, 5 A, thickness of 2 mm)

Although conditions were almost similar to Example 3, using the identical molding apparatus, the following injection-molded product was molded under the conditions of the injection pressure of 120 to 124 MPa.

Shape of injection-molded product: small piece for bending test (strip, length 80 mm×width 10 mm×thickness 4 mm)

Both exhibited satisfactory injection moldability without the generation of burrs. Table 3 shows the physical values of these pellets R4. Compared with the transparent pellets P1 of Comparative Example 1, which were made only of the polyethylene terephthalate, the pellets R4 were: 2.4 times the tensile strength, 5.0 times the Young's modulus, 2.8 times the bending strength, and 6.8 times the flexural modulus.

### Comparative Example 1

### Production of Pellets P1 with Only Polyethylene Terephthalate (PET)

Using only 3 kg of commercially available general-purpose product pellets for PET bottle (the IV value of 0.80, and the MFR (at 260° C. and under a load of 2.16 kg) of 10 g/10 minutes), the pellets P1 were produced under extrusion conditions almost similar to Example 3 and Example 4 to obtain 2.9 kg of transparent pellets. The strand drooped like a bow from the mold outlet to a water surface and meandered in the basin, exhibiting small melt tension. These transparent pellets P1 were cylindrical with a diameter of about 3 mm×length of about 5 mm. The MFR (under a load of 2.16 kg) was a comparatively low melt viscosity, 17 g/10 minutes (at 260° C.) and 57 g/10 minutes (at 280° C.).

These pellets P1 made only of the polyethylene terephthalate were injection-molded similar to Example 3 and Example 4, thus molding a tensile specimen and a bending specimen. The tensile strength was 59 MPa, the Young's modulus was 1.9 GPa, the bending strength was 84 MPa, and the flexural modulus was 2.1 GPa.

TABLE 3
Physical properties of modified polyethylene terephthalate
(pellets) reinforced with recovered carbon fiber

| | Production example number | | |
|---|---|---|---|
| | (pellet designation) | | |
| | Comparative | | |
| | Example 1 | Example 3 | Example 4 |
| | (P1) | (R3) | (R4) |
| Content of recovered | 0 | About 15 | About 30 |
| carbon fiber (wt. %) | | | |
| Pellet shape: | About | About | About |
| diameter × length (mm) | 3.0 × 5 | 2.5 × 4.5 | 3.0 × 5 |
| MFR at 280° C. and | 57 | 35 | 25 |
| under a load of 2.16 kg | | | |
| (g/10 min.) | | | |
| Tensile strength (MPa) | 59 | 120 | 144 |
| Young's modulus (GPa) | 1.9 | 4.0 | 9.5 |
| Bending strength (MPa) | 84 | 194 | 232 |
| Flexural modulus (GPa) | 2.1 | 8.1 | 14.2 |
| Specific gravity | 1.35 | 1.41 | 1.47 |

### Comparative Example 2

### Production of Pellets Made of Commercially Available Polyethylene Terephthalate and Carbon Fiber Industrial Product

Commercially available general-purpose product pellets for PET bottle (the IV value of 0.80, and the MFR (at 260° C. and under a load of 2.16 kg) of 10 g/10 minutes) and a carbon fiber industrial product (TORAYCA T700) were used and blended to measure the MFR of two kinds of pellets. Using a twin-screw extruder having a side feeder with a bore of 35 mm, the pellets were produced under extrusion conditions almost similar to Example 1 to obtain about 3 kg of black pellets respectively. The MFR (at 260° C. and under a load of 2.16 kg) of the pellets in which 10% by weight of TORAYCA T700 was added was 25 g/10 minutes, and the MFR (at 260° C. and under a load of 2.16 kg) of the pellets in which 15% by weight of TORAYCA T700 was added was 25 g/10 minutes. The MFRs were both 20 g/10 minutes or more and exhibited low melt viscosity.

The molding process method is explained below.

### Example 5

### Production Example of Thin Flat Board and Thin Foamed Board from Pellet R1 of Modified Polyethylene Terephthalate Reinforced with Carbon Fiber by Horizontal Extrusion Method, Consisting of Polyethylene Terephthalate, 15% by Weight of Carbon Fiber Chop Produced by Zoltek Corporation, and Modifier

The dried black pellets R1 (MFR (at 260° C. and under a load of 2.16 kg): 6.2 g/10 minutes) made of a polyethylene terephthalate reinforced with carbon fiber (15% by weight) from Zoltek Corporation, the coupling agent (MARPROOF G-0130SP), the coupling reaction catalyst (white powder composite catalyst C10), a chemical foaming agent pellet (EE405F produced by EIWA CHEMICAL IND. CO., LTD., a baking soda-based polyethylene base, an amount of generated gas of 66 ml/g, mainly a carbon dioxide gas), and 0.1 part by weight of a liquid paraffin as the spreader were mixed in advance by the proportions shown in Table 4 and were introduced into the hopper.

A raw material supplying machine, a profile mold, a resin pressure measurement sensor, an air cooler, a sliding plate made of a stainless steel, a basin, and a taking-in machine were installed to a twin-screw extruder produced by TECHNOVEL CORPORATION (bore: 15 mm, UD=30). The composition was horizontally extruded at a screw temperature of 245 to 280° C., a rotation speed of 150 rpm, a mold temperature of 250 to 260° C., a supply speed of the composition such as the pellets of 1 to 2 kg/h, and a taking-in speed of 1 to 2 m/minute. Considering the melt viscosity, the fluidity, the shrinkage, and similar specifications of the resin, as the profile molds, a drum shape (width: 25 mm, a clearance at the center: 2.5 mm, and clearances at both ends: 1.5 mm) was used for thin flat board, and a hand drum shape (width: 25 mm, clearance at the center: 2.5 mm, and clearances at both ends: 4.5 mm) was used for foamed board. Table 4 summarizes the test results.

The profile molding by the horizontal extrusion method stabilizes the production of the molded products as the resin pressure increases. Additionally, as the molded product approaches the width (25 mm) and the clearance (25 mm) of the profile mold, the molding process is more likely to succeed. The foaming ratio of the present invention is preferably 1.5 to 3 times. The present invention is aimed at a huge application such as natural wood and synthetic wood.

In the production of the thin flat board (Slat) 5-S1 of this example, the resin pressure was 0.1 MPa, and the melt tension of the resin was low. Accordingly, a neck-in occurred at the right and left and the top and bottom of the thin flat board, resulting in the thin and slim molded product. In the production of the foamed board 5-F1 in this example, although the addition of 2.5 parts by weight of the foaming agent increased the respective width and thickness, the width and the thickness were insufficient. Further, in the production of the foamed board 5-F2 in this example, the addition of 0.4 part by weight of the coupling agent as the modifier (MARPROOF G-0130SP) and 0.2 part by weight of the coupling reaction catalyst (C10) in addition to 2.5 parts by weight of the foaming agent doubled the resin pressure and also increased the width (19 mm) and the thickness (2.3 mm) of the foamed board, reaching the foaming ratio to 1.5 times. These mean the increase of the additive amount, 2.5 parts by weight, of the foaming agent to 3 to 4 parts by weight ensures further improvement and control. Especially, although a dimension measurement mold was not used for the foamed board 5-F2 of this example, the foamed board exhibited good surface smoothness and stable molding state; therefore, the additive effect of the modifier was remarkable.

TABLE 4
Production results of thin flat board and thin
foamed board from pellets R1 of Example 1
by horizontal extrusion method

| | Composition | | | |
|---|---|---|---|---|
| | ratio | | | |
| | (part by weight) | | | Molded |
| | Pellets R1/ | | Width × | product |
| Example | coupling agent/ | Resin | average | shape |
| test | catalyst/ | pressure | thickness | Foaming |
| number | foaming agent | (MPa) | (mm) | ratio |
| Example | 100/0/0/0 | 0.1 | 13 × 0.96 | Thin flat |
| 5-S1 | | | | board |
| | | | | — |
| Example | 100/0/0/2.5 | 0.3 | 16 × 1.7 | Foamed |
| 5-F1 | | | | board |
| | | | | 1.3 |
| Example | 100/0.4/0.2/2.5 | 0.7 | 19 × 2.3 | Foamed |
| 5-F2 | | | | board |
| | | | | 1.5 |

### Example 6

### Production Example of Thin Flat Board and Thin Foamed Board from Pellets R2 of Modified Polyethylene Terephthalate Reinforced with Carbon Fiber by Horizontal Extrusion Method, Consisting of Polyethylene Terephthalate, 30% by Weight of Carbon Fiber Chop Produced by Zoltek Corporation, and Modifier

A thin flat board and a thin foamed board were produced under extrusion conditions and operations similar to Example 5. Table 5 summarizes the test results. The dried black pellets R2 (MFR (at 260° C. and under a load of 2.16 kg): 6.7 g/10 minutes) made of a polyethylene terephthalate reinforced with carbon fiber (30% by weight) produced by Zoltek Corporation, the coupling agent (MARPROOF G-0130SP), the coupling reaction catalyst (C10), the chemical foaming agent pellet (EE405F produced by EIWA CHEMICAL IND. CO., LTD., the amount of generated gas of 66 ml/g), and 0.1 part by weight of a liquid paraffin as the spreader were mixed in advance by the proportions shown in Table 5 and were introduced into the hopper.

In the production of the thin flat board 6-S2 of this example, the resin pressure was 0.2 MPa, and the melt tension of the resin was slightly low. Accordingly, a neck-in occurred as had been expected at the right and left and the top and bottom of the thin flat board, resulting in the thin and slim molded product. Next, in the production of the foamed board 6-F3 in this example, the addition of 2.5 parts by weight of the foaming agent increased the respective width (18 mm) and thickness (2.1 mm), reaching a foaming ratio to 1.5 times. In the production of the foamed board 6-F4 in this example, the further addition of 0.4 part by weight of the coupling agent as the modifier and 0.2 part by weight of the coupling reaction catalyst in addition to 2.5 parts by weight of the foaming agent increased the resin pressure to 10 times, 2.3 MPa, and also increased molding stability of the width (18 mm) and the thickness (2.1 mm) of the foamed board. Additionally, the foaming ratio was able to reach 2.0 times, the target for the time being. As apparent from the various examples, the combination use and the addition of the modifier are necessary and indispensable for the production of the foamed board.

TABLE 5
Production results of thin flat board and thin foamed board
from pellets R2 of Example 2 by horizontal extrusion method

| | Composition ratio (part by | | Width × average | Molded product |
|---|---|---|---|---|
| Example test | weight) Pellet R2/coupling | Resin pressure | thickness | shape Foaming |
| number | agent/catalyst/foaming agent | (MPa) | (mm) | ratio |
| Example | 100/0/0/0 | 0.2 | 13 × 1.2 | Thin flat board |
| 6-S2 | | | | — |
| Example | 100/0/0/2.5 | 0.7 | 18 × 2.1 | Foamed board |
| 6-F3 | | | | 1.5 |
| Example | 100/0.4/0.2/2.5 | 2.3 | 18 × 2.1 | Foamed board |
| 6-F4 | | | | 2.0 |

### Example 7

### Production of Thin Flat Board from Pellets R3 and R4 of Modified Polyethylene Terephthalate Reinforced with Recovered Carbon Fiber by Horizontal Extrusion Method

For factory production of a U-shaped steel by profile extrusion, an optimal additive amount of modifier masterbatch (MB-E: Production Example 3) was determined through testing. The pellets R3 and R4 of modified polyethylene terephthalate reinforced with recovered carbon fiber both exhibit large MFR and comparatively small melt viscosity. Accordingly, using a facility and a method similar to Examples 5 and 6, a thin flat board was horizontally extruded and preliminarily tested the additive amount of the modifier masterbatch indispensable for profile extrusion to determine the additive amount. Note that, considering the melt viscosity, the fluidity, the shrinkage, and similar specifications of the resin, the profile mold with a rectangular shape (width 25 mm, clearance at the center: 1.5 mm) was used. Table 6 summarizes the test results. As the increase in the additive amount of the modifier (MB-E), the resin pressure was increased and the width and the thickness of the thin flat board were significantly increased, thereby determining the optimal additive amount as 6 parts by weight.

TABLE 6
Production results of thin flat boards from pellet R3 of
Example 3 and pellet R4 of Example 4 by extrusion method

| Example test | Composition ratio (part by | Resin pressure | Width × thickness | Shape |
|---|---|---|---|---|
| number | weight) Pellet/modifier (MB-E) | (MPa) | (mm) | Remarks |
| Example 7-1 | R3 (CF: 15%) 100/0 | 0.0 | 13 × 1.1 | Thin flat board |
| | | | | Slim |
| Example 7-2 | R3 (CF: 15%) 100/4 | 0.6 | 19 × 1.9 | Thin flat board |
| | | | | Thick |
| Example 7-3 | R4 (CF: 30%) 100/4 | 0.5 | 16 × 1.7 | Thin flat board |
| | | | | Slightly slim |
| Example 7-4 | R4 (CF: 30%) 100/6 | 1.2 | 18 × 2.2 | Thin flat board |
| | | | | Thick |

### Example 8

### Factory Production of U-Shaped Profile Product from Pellets R3 and R4 of Modified Polyethylene Terephthalate Reinforced with Recovered Carbon Fiber by Horizontal Extrusion

The factory production of the U-shaped profile product by the profile extrusion was satisfactory conducted with a basic combination ratio: pellets R3 or R4 of modified polyethylene terephthalate reinforced with recovered carbon fiber/modifier (MB-E)=100 parts by weight/6 parts by weight. The shape of the “U-” shaped profile product containing the recovered carbon fiber by about 15 weight % and 30 weight % was: a length of a bottom surface of 37 mm, a height of ribs at both ends of 33 mm, a thickness of 2.5 mm, and a length of 2 m, specified length.

### Example 9

### Production Example of Pellets R5 (15% by Weight of CF) and R6 (30% by Weight of CF) of Modified Polyethylene Terephthalate Reinforced with Carbon Fiber Produced by Zoltek Corporation

The pellets R5 and R6 of modified polyethylene terephthalate reinforced with carbon fiber produced by Zoltek Corporation were mass-produced by the identical apparatuses and the identical conditions to Example 1 and Example 2. The pellets R5 (15% by weight of CF) of modified polyethylene terephthalate reinforced with carbon fiber produced by Zoltek Corporation were: the amount of production of 905 kg, the specific gravity of 1.377, the MFR (at 260° C. and under a load of 2.16 kg) of 9.2 g/10 minutes, and the pellet length of 6 mm.

The pellets R6 (30% by weight of CF) of modified polyethylene terephthalate reinforced with carbon fiber produced by Zoltek Corporation were: the amount of production of 1,050 kg, the specific gravity of 1.457, the MFR (at 260° C. and under a load of 2.16 kg) of 6.5 g/10 minutes, and the pellet length of 6 mm.

### Example 10

### Production Example of Pipe from Pellets R6 (30% by Weight of CF) of Modified Polyethylene Terephthalate Reinforced with Carbon Fiber Produced by Zoltek Corporation by Horizontal Extrusion Method

The pellets R6 (30% by weight of CF) of modified polyethylene terephthalate reinforced with carbon fiber produced by Zoltek Corporation from Example 9 were dehumidified and dried for four hours at 140° C., and were introduced into a hopper of a single-screw extruder with 65-mm bore to which a pipe-shaped die was installed. After setting cylinder and die temperatures to 150 to 280° C., the screw was rotated to start the pipe extrusion. A soft dough-like pipe was passed through a female mold doubling as dimension measurement and cooling at a speed of 1 to 2 m/minutes to mold a pipe. While a taking-in machine takes in the pipe, an automatic cutting machine running side by side cut off the pipe at a specified length of 2 m. The shape of the pipe was: outer shape 28 mm×inner diameter 24 mm, wall thickness of 2 mm, and length of 2 m.

### Example 11

### Production Example of 30 cm-Width Flat Board and Foamed Board from Pellets R5 and R6 of Modified Polyethylene Terephthalate Reinforced with Carbon Fiber Produced by Zoltek Corporation by T-Die Extrusion Method

The pellets R5 and R6 produced in Example 9 were produced using a T-die sheet extrusion manufacturing apparatus produced by SOUKEN Co., Ltd. This single-screw extruder has a bore of 30 mm, L/D=38, and a full-flight screw. The T-die was a coat hanger type with 300-mm width, and a lip clearance at this time was designed to be 1.0 mm. A polishing roll made of a stainless steel is mirror-finished and performs an oil temperature control. A guide roll performs a warm water control. The taking-in machine is a rubber roll performing a pneumatic control.

100 parts by weight of the black pellets R5 (MFR (at 260° C. and under a load of 2.16 kg): 9.2 g/10 minutes) of the modified polyethylene terephthalate reinforced with carbon fiber (15% by weight) produced by Zoltek Corporation after dried at 120° C. for one night, 0 to 6 parts by weight of the modifier masterbatch (MB-E), 1 to 2 parts by weight of the chemical foaming agent pellet EE405F (produced by EIWA CHEMICAL IND. CO., LTD., the amount of generated gas of 66 ml/g), 0.1 part by weight of the calcium stearate as a lubricant, and 0.05 part by weight of a liquid paraffin as the spreader were mixed in advance and were introduced into a hopper of a main extruder.

The taking-in speed was set to 0.5 to 0.9 m/minute at a cylinder temperature of 250 to 280° C., the temperature of T-die of 270° C., the number of screw rotations of 92 rpm, and the roll temperature of 60° C. to produce a flat board and a foamed board with 30 cm-width. Table 7 shows conditions for the production test and transitions of the shape of the product and similar specifications. Table 8 shows the specific gravity, the mechanical strength, and similar specifications of the products.

The use of 3 to 6 parts by weight of the modifier masterbatch (MB-E) in combination significantly increased the resin pressure, stabilizing the moldability of the flat board, especially stabilizing the moldability of the foamed board. The strength of the flat board was improved.

TABLE 7
Production examples of flat boards and foamed boards
from pellets R5 (CF: 15%) and pellets R6 (CF: 30%)

| | Composition ratio (part by | | | Molded product |
|---|---|---|---|---|
| Example test | weight) Pellets/modifier | Resin pressure | Width × average | shape Foaming |
| number | (MB-E)/foaming agent | (MPa) | thickness (mm) | ratio |
| Example 11-1 | R5 (CF: 15%) 100/0/0 | 2.0 | 28 × 1.0 | Flat board |
| | | | | — |
| Example 11-2 | R5 (CF: 15%) 100/3/0 | 2.7 | 29 × 1.0 | Flat board |
| | | | | — |
| Example 11-3 | R5 (CF: 15%) 100/3/2 | 1.4 | 30 × 1.1 | Foamed board |
| | | | | 1.4 |
| Example 11-4 | R5 (CF: 15%) 100/6/1 | 2.5 | 29 × 1.1 | Foamed board |
| | | | | 1.4 |
| Example 11-5 | R6 (CF: 30%) 100/0/0 | 3.5 | 29 × 1.0 | Flat board |
| | | | | — |
| Example 11-6 | R6 (CF: 30%) 100/4/2 | 2.2 | 30 × 1.1 | Foamed board |
| | | | | 1.4 |

TABLE 8
property examples of flat boards and foamed boards
from pellets R5 (CF: 15% and pellets R6 (CF: 30%)

| | Plate | | Tensile | Young's | Bending | Flexural | |
|---|---|---|---|---|---|---|---|
| Example test | thickness | Specific | strength | modulus | strength | modulus | Molded product shape |
| number | (mm) | gravity | (MPa) | (GPa) | (MPa) | (GPa) | Foaming ratio |
| Example 11-1 | 1.0 | 1.353 | 81 | 5.8 | 132 | 5.6 | Flat board |
| | | | | | | | — |
| Example 11-2 | 1.0 | 1.336 | 84 | 5.6 | 149 | 6.8 | Flat board |
| | | | | | | | — |
| Example 11-3 | 1.1 | 0.949 | 37 | 3.3 | 87 | 5.4 | Foamed board |
| | | | | | | | 1.4 |
| Example 11-4 | 1.1 | 0.955 | 41 | 3.6 | 83 | 5.7 | Foamed board |
| | | | | | | | 1.4 |
| Example 11-5 | 1.0 | 1.364 | 94 | 10.4 | 170 | 10.9 | Flat board |
| | | | | | | | — |
| Example 11-6 | 1.1 | 0.974 | 43 | 6.5 | 100 | 9.3 | Foamed board |
| | | | | | | | 1.4 |

### Example 12

### Production of Wide-Width Foamed Board from Pellets R5 of Modified Polyethylene Terephthalate Reinforced with Carbon Fiber, Consisting of Polyethylene Terephthalate, Carbon Fiber Chop (30% by Weight) Produced by Zoltek Corporation, and Modifier by Carbon Dioxide Gas Injection Method

A first hopper and a weight measurement machine, a second hopper and a capacity measurement machine, a vent-type vacuum line, a temperature control apparatus, a carbon dioxide gas injection apparatus, an injection line, a gear pump, a T-die (width of 1,200 mm, for horizontal extrusion), a horizontal cooling apparatus, a taking-in apparatus, an automatic cutting machine, and a similar apparatus were installed to a codirectional twin-screw extruder (bore: 60 mm, L/D=40).

The undried pellets R5 (30 weight % of carbon fiber produced by Zoltek Corporation, specific gravity of 1.457, MFR (at 260° C. and under a load of 2.16 kg) of 6.5 g/10 minutes) of modified polyethylene terephthalate reinforced with carbon fiber was introduced into the first hopper, and the modifier pellets (MB-E) were introduced into the second hopper. In the extruder, temperatures of the cylinder, the gear pump, and the T-die were set to 240 to 280° C. The extruder was a two-vent system dehumidified under a high vacuum. The extrusion speed of the resin composition was set to 75 kg/h, and the amount of injected carbon dioxide gas was set to 2.5 to 5 g/minute. The additive amount of the modifier pellets (MB-E) to the second hopper was controlled to control a screw distal end pressure to 6 to 7 MPa. While the additive amount of the modifier pellets (MB-E) was affected by the additive amount of the carbon dioxide gas, which has a plasticizing effect, the additive amount is 4 to 8 parts by weight with respect to 100 parts by weight of the pellets R5. Thus, a foamed board with a width of about 120 cm, average thickness of 2.2 to 2.4 mm, and foaming ratio of 1.5 to 2 times was produced.

As thermoplastic polyester of constituent (A) as the main raw material, recycled PET bottles/flakes (IV value: 0.73), which is inexpensive and features good quality, can also be excellently used.

### INDUSTRIAL APPLICABILITY

According to the present invention, to produce the modified polyester resin reinforced with carbon fiber, the modifier (the coupling agent and the catalyst) was used in combination to enhance the melt viscosity. Thus, products molded by the horizontal extrusion method by which profile extrusion molding was conventionally difficult were able to be produced extremely stably. The mechanical strength of this new material was able to be dramatically enhanced by the reinforcement of the carbon fiber and ensured weight reduction by the foaming. This also ensures improvement of various physical properties such as corrosion resistance, heat resistance, heat conductivity, conductive property, oil resistance, and weather resistance. New carbon fiber that has been mass-produced at low-cost, unused carbon fiber recovered from aircraft assembly, and recycled carbon fiber made from carbon fiber-reinforced epoxy resin composite material, which will emanate from the large amounts of scrap from aircraft bodies generated in the near future, are also applicable.

The present invention is aimed at applications in civil engineering and construction materials for the time being. In the near future, the present invention is aimed at applications for further weight reduction and energy saving through improvement in strength of interior materials and constituent materials in advanced industrial fields such as railway vehicles, the automotive industry, Shinkansen train business, linear motor cars, and the aerospace industry. Additionally, this can further improve performance such as radio wave absorbency, conductive properties, heat resistance, and heat radiation performance; therefore, the present invention has great possibilities for usage in the functional materials field.

1. A method for producing a molded product of a modified polyester resin reinforced with carbon fiber, comprising
reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester by a reactive extrusion method to prepare a modified polyester resin reinforced with carbon fiber having an MFR in accordance with JIS K6760 (at 260° C. and under a load of 2.16 kg) of 20 g/10 minutes or less; and
subsequently molding the modified polyester resin reinforced with carbon fiber into a sheet, a board, or a profile extruded product.

2. A method for producing a foamed product of a modified polyester resin reinforced with carbon fiber, comprising:
reacting a mixture composed of (A) 100 parts by weight of a thermoplastic polyester, (B) 5 to 150 parts by weight of a carbon fiber, (C) 0.1 to 2 parts by weight of a coupling agent consisting of a polyfunctional epoxy compound having two or more epoxy groups in a molecule and having a weight-average molecular weight of 2,000 to 10,000, (D) 0.01 to 1 part by weight of a coupling reaction catalyst and (E) 0.01 to 1 part by weight of a spreader at a temperature equal to or more than a melting point of the thermoplastic polyester by a reactive extrusion method to prepare a modified polyester resin reinforced with carbon fiber having an MFR in accordance with JIS K6760 (at 260° C. and under a load of 2.16 kg) of 20 g/10 minutes or less; and
subsequently foam-molding the modified polyester resin reinforced with carbon fiber by using a foaming gas of one or more kinds selected from the group consisting of a chemical forming gas, a volatile gas, and an inert gas.
